(19) United States
(12) Patent Application Publication
(10) Pub. No.: US 2024/0397930 A1
(43) Pub. Date: Dec. 5, 2024

(54) Insect and Fly Repelling Device with Small Storage Volume

(71) Applicant: Shenzhen Maichen Suchuang Technology Co., Ltd, Shenzhen (CN)

(72) Inventor: Haichao Wang, Shenzhen (CN)

(21) Appl. No.: 18/204,946

(22) Filed: Jun. 2, 2023

(51) Int. Cl. A01M 29/06

(52) U.S. Cl. CPC A01M 29/06; A01M 2200/012

(57) ABSTRACT

The present invention discloses a retractable insect and fly repelling device, which comprises an insect and fly repelling module, a sleeve assembly for receiving the insect and fly repelling module, and a base body for accommodating and supporting the sleeve assembly, wherein the sleeve assembly comprises at least one sleeve, and also comprises a track and slider structure for guiding the sleeve assembly into an accommodating state or a use state; the track and slider structure comprises a track device and a slider device, and the track device is fixed to the sleeve or the base body and configured to extend upward from the bottom of the sleeve or the base body.

### TECHNICAL FIELD

The present invention relates to the technical field of insect repelling, in particular to an insect and fly repelling device with a small storage volume.

### BACKGROUND

In summer, there are many mosquitoes and flies on the dining table, fruit bowls or stalls. In order to avoid the pollution of fruits or food by mosquitoes and flies, many users drive away mosquitoes and flies by using fly-driving fans.

However, in the prior art, most mosquito-repelling fans are of integrated structure, and their volume is relatively large, so they often need to occupy a relatively large storage space when idle. For example, U.S. Patent NO. 20200093119 discloses a flying insect deterrent system and device, including a rotating element, a vertical column, a rope, a rope element and a motor. The insect deterrent device comprises a vertical column, a rotating element, a motor, a rope and rope elements, wherein the rotating device is located at the top of the vertical column and is driven by the motor, and the motor rotates the rope connected to the rotating device to prevent flying insects from flying or landing in the area.

There is also a split-type insect repelling fan in the market. Its structure includes a base body, a first sleeve and a second sleeve fixedly connected to the base body. After the three are fixedly connected, they form a whole, which generally does not need to be split twice, which leads to the large overall size of the product and some inconvenience in storage. In addition, the base body, the first sleeve and the second sleeve are all narrow at the top and wide at the bottom, and the battery box is fixed at the lower part of the base body and the motor is fixed at the upper part of the second sleeve. Because there is no guide structure between the base body, the first sleeve and the second sleeve, during the assembly process, because of the dislocation between the base body and the first sleeve or between the first sleeve and the second sleeve, the wires connecting the battery box and the motor are easy to fall off, which leads to the scrapping of the products.

Based on the above problems, it is necessary to put forward a brand-new insect and fly repelling device, which has less storage volume, reduces the space occupied when idle, and can guide and maintain the storage and use state of the device at the same time, avoiding the loss of wires between the power supply and the driving device due to the dislocation of the device, and prolonging the service life of the product.

### SUMMARY

The present invention provides a retractable insect and fly repelling device, which comprises an insect and fly repelling module, a sleeve assembly for receiving the insect and fly repelling module, and a base body for accommodating and supporting the sleeve assembly, wherein the sleeve assembly comprises at least one sleeve, and also comprises a track and slider structure for guiding the sleeve assembly into an accommodating state or a use state; the track and slider structure comprises a track device and a slider device, and the track device is fixed to the sleeve or the base body and configured to extend upward from the bottom of the sleeve or the base body.

The retractable insect and fly repelling device provided by the present invention is further provided with a locking structure on the sleeve assembly and the base body, and the use state of the device is maintained through the locking structure.

### BRIEF DESCRIPTION OF DRAWINGS

In order to explain the technical solution of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of the use state of a retractable insect and fly repelling device of the present invention;

FIG. 2 is a schematic diagram of the accommodating state of a retractable insect and fly repelling device of the present invention;

FIG. 3 is a cross-sectional view of a retractable insect and fly repelling device of the present invention;

FIG. 4 is a sectional view of the sleeve of the present invention;

FIG. 5 is a sectional view of the base body of the present invention;

FIG. 6 is a cross-sectional view of the use state of the insect and fly repelling device (without the insect and fly repelling module) with only one sleeve;

FIG. 7 is a cross-sectional view of the use state of the insect and fly repelling device (without the insect and fly repelling module) provided with only two sleeves.

### IN THE FIGURES

100, Insect and fly repelling module; 111, Blades; 200, Sleeve assembly; 210, Sleeve; 211, First sleeve; 212, Second sleeve; 213, Motor seat; 220, Support table; 230, First flange; 240, Locking part; 260, Second flange; 270, Clamping part; 300, Base body; 310, Bottom cover; 320, Third flange; 330, Stopping part; 400, Track device; 410, Track; 411, Chute; 412, Chute; 500, Slider device; 510, Slider; 600, Support seat.

### DESCRIPTION OF EMBODIMENTS

In the following, the technical solution in the embodiment of the application will be clearly and completely described with reference to the drawings in the embodiment of the application. Obviously, the described embodiment is only a part of the embodiment of the application, but not the whole embodiment. Based on the embodiments in this application, all other embodiments obtained by those skilled in the art without creative labor belong to the protection scope of this application.

Reference to “an example” or “an embodiment” herein means that a particular feature, structure or characteristic described in connection with an embodiment or an embodiment can be included in at least one embodiment of this application. The appearance of this phrase in various places in the specification does not necessarily refer to the same embodiment, nor is it an independent or alternative embodiment mutually exclusive with other embodiments. It is understood explicitly and implicitly by those skilled in the art that the embodiments described herein can be combined with other embodiments.

In this specification, for the sake of convenience, words and expressions indicating orientation or positional relationship such as “middle”, “upper”, “lower”, “front”, “rear”, “vertical”, “horizontal”, “top”, “inner” and “outer” are used to illustrate the positional relationship of constituent elements with reference to the attached drawings, only for the convenience of description. The positional relationship of the constituent elements is appropriately changed according to the direction of the described constituent elements. Therefore, it is not limited to the words and expressions described in the specification, and can be replaced appropriately according to the situation.

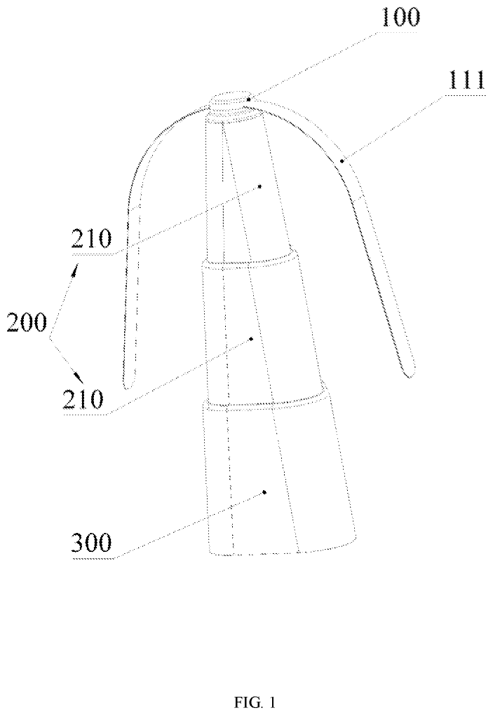

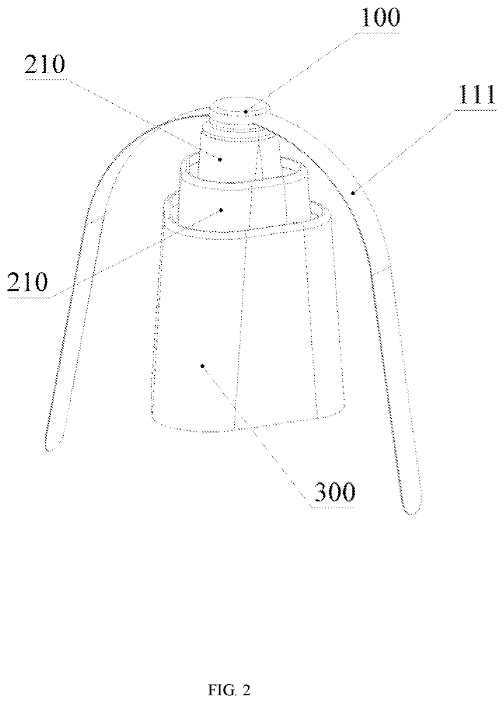

As shown in FIG. 1, a retractable insect and fly repelling device provided by the present invention includes an insect and fly repelling module 100, a sleeve assembly 200 for receiving the insect and fly repelling module 100, and a base body 300 for accommodating and supporting the sleeve assembly 200, wherein the sleeve assembly 300 includes at least one sleeve 210, and as shown in FIG. 2, the sleeve assembly 200 is retractably accommodated in the base body 300 to reduce the storage volume of the insect and fly repelling device.

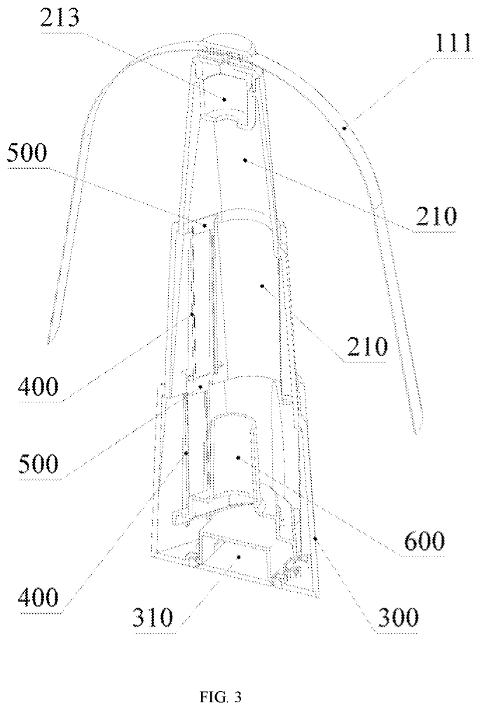

As a preferred embodiment of the present invention, in order to avoid the disadvantage that the existing insect and fly repelling device is prone to dislocation when it is extended and retracted, the insect and fly repelling device provided by the present invention further includes a track and slider structure for guiding the sleeve assembly 200 into an accommodating state or a use state. As shown in FIG. 3, the track and slider structure includes a track device 400 and a slider device 500. The track device 400 is fixed to the sleeve 210 or the base body 300, and it is configured to extend upward from the bottom of the sleeve 210 or the base body 300. The cross-sectional areas of the sleeve 210 and the base body 300 are increasing from the top to the bottom, and both are hollow structures with open ends. When the sleeve assembly 200 is guided to the use state by the track and the slider structure, the insect and fly repelling device is in a steeple shape as a whole.

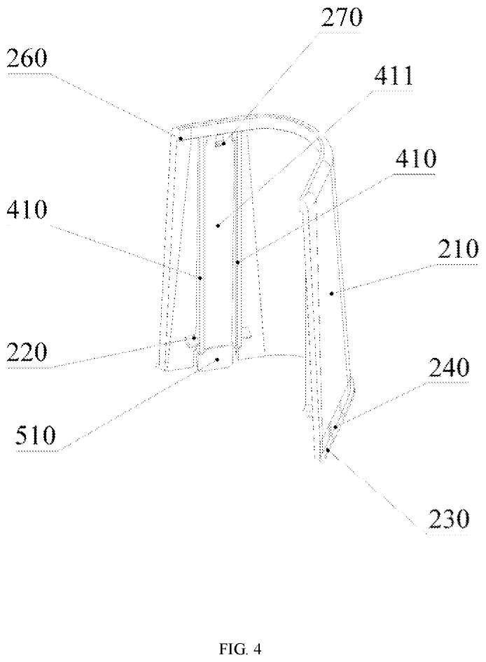

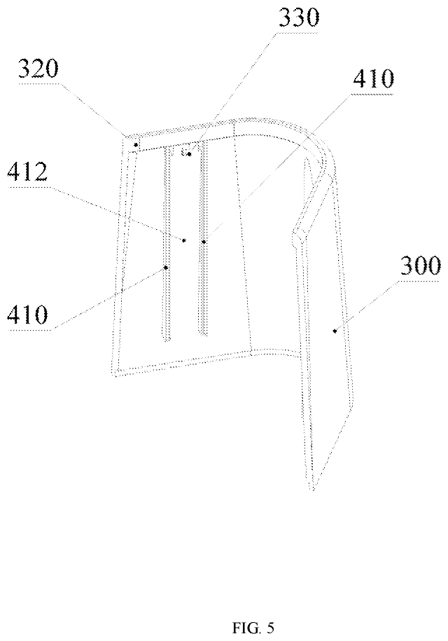

Specifically, as shown in FIGS. 4 and 5, the track device 400 includes a track 410 extending upward from the bottom of the sleeve 210 or the base body 300, and the slider device 500 includes a slider 510 formed inside the sleeve 210 or the base body 300 and adapted to be received by the track 410.

In this embodiment, both the sleeve 210 and the base body 300 are provided with a track device 400, which is integrally formed with the sleeve 210 and the base body 300 and includes two tracks 410. The two tracks 410 are arranged in a relatively parallel manner and extend upward from the bottom of the sleeve 210 to form a chute 411, and extend upward from the bottom of the base body 300 to form a chute 412, wherein two end faces of the chute 411 and the two end faces of the chute 412 coincide with each other.

The slider 510 is formed at the bottom of the sleeve 210 and configured to slide in the chute 411 or the chute 412 to guide the expansion and contraction of the sleeve 210 and make the sleeve 210 have a large expansion and contraction range. In some embodiments, the slider 510 can be arranged in the middle of the sleeve 210 or at other heights according to actual use requirements. In this embodiment, the width of the slider 510 is the same as that of the chute 411, which makes the retraction and accommodating process of the sleeve 210 more stable and not easy to shake. In some embodiments, the width of the slider 510 can be slightly smaller than that of the chute 411 or the chute 412, for example, there is a gap of 0.05 mm to 1 mm between one end face of the slider 510 and the corresponding track 410, so as to reduce the sliding friction of the slider 510 in the chute 411 or the chute 412, so that the stretching and retracting and accommodating of the sleeve body 210 is more labor-saving and the loss caused by friction is reduced.

In some embodiments, in order to reduce the manufacturing cost or make the device lighter, the number of the tracks 410 can also be configured as one. At this time, the slider 510 will no longer guide the retraction and accommodating of the sleeve 210 through the chute, but will be coupled with the track 410, and the track 410 will be used to guide the retraction and accommodating of the sleeve 210. In other embodiments, in order to further increase the stability of the sleeve 210 during expansion and storage, the number of tracks 410 can be three or more, and at the same time, a plurality of chutes 411 or chutes 412 are correspondingly formed, and a plurality of sliders 510 are formed, so as to further avoid the dislocation of the sleeve 210 during expansion and storage.

As a preferred embodiment of the present invention, in order to maintain the retraction and accommodating state of the sleeve 210, as shown in FIGS. 4 and 5, the bottom end of the sleeve 210 extends outward to form a first flange 230, the top end of the sleeve 210 extends inward to form a second flange 260, and the top end of the base body 300 extends inward to form a third flange 320. A locking part 240 is formed at the bottom of the sleeve 210, a clamping part 270 is formed at the top of the sleeve 210, and a stopping part 330 is formed at the top of the base body 300.

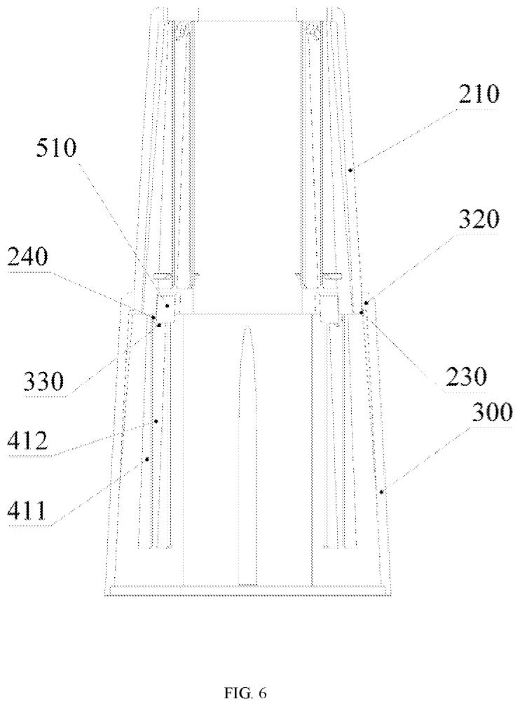

When the sleeve 210 is guided into the use state by the track and slider structure, as shown in FIG. 6, in this embodiment, the number of the sleeve 210 is one. The upper surface of the first flange 230 of the sleeve 210 abuts against the lower surface of the third flange 320 of the base body 300, wherein the locking part 240 is locked to the stopping part 330, and the sleeve body 210 is kept in the use state through the locking cooperation between the locking part 240 and the stopping part 330.

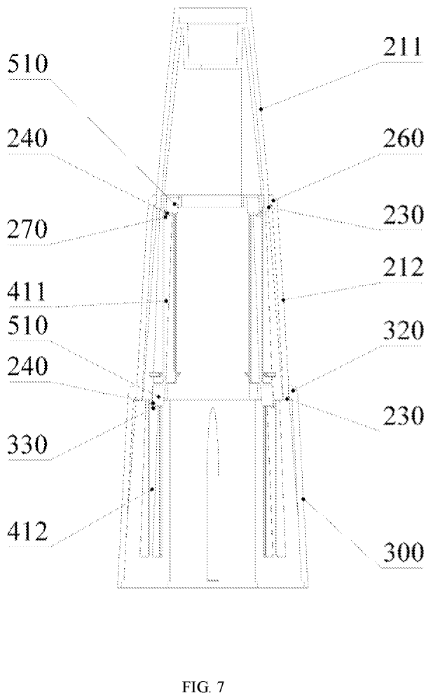

As shown in FIG. 7, as a preferred embodiment of the present invention, the sleeve 210 includes a first sleeve 211 and a second sleeve 212. When the first sleeve 211 and the second sleeve 212 are guided into the use state by the track and slider structure, the upper surface of the first flange 230 of the first sleeve 211 abuts against the lower surface of the second flange 260 of the second sleeve 212, the upper surface of the first flange 230 of the second sleeve 212 abuts against the lower surface of the third flange 320 of the base 300. The locking part 240 of the first sleeve 211 is locked with the clamping part 270 of the second sleeve 212, and the locking part 240 of the second sleeve 212 is locked with the stopping part 330 of the base body 300, so that the retractable use state of the insect and fly repelling device is maintained through the locking cooperation of a plurality of locking structures.

In some embodiments, the number of sleeves 210 can be more configured to meet the use needs of different users, for example, four or five sleeves are provided to make the insect and fly repelling device have a higher expelling height.

As a preferred embodiment of the present invention, the locking part 240 is arranged at the top of the chute 411, the clamping part 270 is arranged at the bottom of the slider 510, and the stopping part 330 is arranged at the top of the chute 412, so that the retractable storage process of the sleeve 2 is more stable and the storage effect is better. In other embodiments, the locking structure can be arranged at other positions and heights to meet the actual use needs of users.

In this embodiment, the locking structure is integrally formed with the sleeve 210 or the base body 300, and both the sleeve 210 and the base body 300 are made of plastic, so that the locking structure has certain elasticity, and the user can overcome the elastic stress of the plastic to complete the locking fit of the locking structure during the retractable operation of the device, thus greatly prolonging the service life of the insect and fly repelling device. In some embodiments, the locking structure can also be made of elastic metal materials to further increase the service life of the device.

As shown in FIG. 2, when the first sleeve 211 and the second sleeve 212 are guided into the accommodating state by the track and slider structure, the locking part 240 of the first sleeve 211 is far away from the clamping part 270 of the second sleeve 212, and the locking part 240 of the second sleeve 212 is far away from the stopping part 330 of the base body 300, so that the first sleeve 211 is accommodated in the second sleeve 212 and the second sleeve is accommodated in the base body 300.

As a preferred embodiment of the present invention, in order to enable the insect and fly repelling device in the stored state to carry out insect and fly repelling work, as shown in FIG. 3, a support seat 600 is arranged inside the base body 300, and a motor seat 213 is arranged in the first sleeve 211. When the sleeve 210 is integrally accommodated inside the base body 300, the support seat 600 provides support for the motor seat 213, and the support seat 600 and the motor seat 213 are also provided with through holes through which wires can pass. In order to ensure that the insect and fly repelling device can also carry out normal insect and fly repelling work when it is stored. As shown in FIG. 4, the second cover 212 is also provided with a support table 220. When the second cover 212 is accommodated in the base body 300, the support table 220 abuts against the support seat 600, and the support seat 600 provides stable storage support for the second cover 212 through the support table 220, which makes the accommodated insect and fly repelling device more stable.

In the present invention, the insect and fly repelling module 100 includes a fan assembly and a power supply (not shown in the figure). The fan assembly is fixedly connected with the casing 210, including blades 111 and a motor (not shown in the figure). The power supply is fixedly connected with the base body 300 and electrically connected with the motor. The motor is arranged on the motor seat 213, and the blades 111 are rotated by starting the motor, thereby expelling mosquitoes in a certain space.

As shown in FIG. 3, the base body 300 is also provided with a bottom cover 310, which is fixedly connected with the bottom of the base body 300 and closes the opening at the bottom of the base body 300, and a power supply (not shown in the figure) is fixedly connected with the bottom cover 310. In this embodiment, the bottom cover 310 is also provided with a hook (not shown in the figure), and the user can hang the insect repelling device upside down or on the wall through the hook, so that it has various insect and fly repelling effects. In some embodiments, a magnet or an adhesive tape can also be arranged on the bottom cover 310, so that it can be fixed to the surface for use, further increasing the stability of insect and fly repelling work.

According to the retractable insect and fly repelling device provided by the present invention, a guide structure of a track and slider structure is arranged between the base body 300 and the sleeves 210 at all levels, and at the same time, a locking structure is arranged, so that the sliding between the base body 300 and the sleeves 210 at all levels is very stable; in the assembly process of parts, because the relative positions are stable, the connecting wires between the power supply and the motor are not likely to fall off, and the rejection rate of products is reduced; in addition, users can also achieve different insect and fly repellent heights by accommodating the one-level or multi-level sleeve 210, which has wider applicability.

The technical means disclosed in the solution of the present invention are not limited to the technical means disclosed in the above embodiments, but also include the technical solution composed of any combination of the above technical features. It should be pointed out that for those skilled in the art, several improvements and embellishments can be made without departing from the principle of the present invention, and these improvements and embellishments are also regarded as the protection scope of the present invention.

What is claimed is:

1. A retractable insect and fly repelling device, comprising an insect and fly repelling module (100), a sleeve assembly (200) for receiving the insect and fly repelling module (100), and a base body (300) for receiving and supporting the sleeve assembly (200), wherein the sleeve assembly (200) comprises at least one sleeve (210), and further comprises a track and slider structure for guiding the sleeve assembly (200) into an accommodating state or a use state; the track and slider structure comprises a track device (400) and a slider device (500), and the track device (400) is fixed to the sleeve (210) or the base body (300) and configured to extend upward from the bottom of the sleeve (210) or the base body (300).

2. The retractable insect and fly repelling device according to claim 1, wherein the track device (400) comprises a track (410) which extends upward from the bottom of the sleeve (210) or the base body (300); the slider device (500) comprises a slider (510) which is formed inside the sleeve (210) or the base body (300) and is adapted to be received by the track (410).

3. The retractable insect and fly repelling device according to claim 2, wherein the cross-sectional areas of the sleeve (210) and the base body (300) are increasing from top to bottom, and both are hollow structures with open ends; when the sleeve assembly (200) is guided by the track and the slider structure into the use state, the insect and fly repelling device as a whole is in the shape of a steeple.

4. The retractable insect and fly repelling device according to claim 3, wherein a bottom end of the sleeve (210) extends outward to form a first flange (230), a top end of the sleeve (210) extends inward to form a second flange (260), and a top end of the base body (300) extends inward to form a third flange (320).

5. The retractable insect and fly repelling device according to claim 4, wherein a locking part (240) is formed at the bottom of the sleeve (210), a clamping part (270) is formed at the top of the sleeve (210), and a stopping part (330) is formed at the top of the base body (300).

6. The retractable insect and fly repelling device according to claim 5, wherein when the sleeve (210) is guided by the track and the slider structure into the use state, an upper surface of the first flange (230) abuts against a lower surface of the third flange (320); the locking part (240) is locked with the stopping part (330), and the sleeve body (210) is kept in the use state through the locking cooperation between the locking part (240) and the stopping part (330).

7. The retractable insect and fly repelling device according to claim 6, wherein the sleeve assembly (200) comprises a first sleeve (211) and a second sleeve (212), and when the first sleeve (211) and the second sleeve (212) are guided by the track and the slider structure into the use state, an upper surface of the first flange (230) of the first sleeve (211) abuts against a lower surface of the second flange (260) of the second sleeve (212), and an upper surface of the first flange (230) of the second sleeve (212) abuts against the third flange (300) of the base body (300).

8. The retractable insect and fly repelling device according to claim 7, wherein the locking part (240) of the first sleeve (211) is locked with the clamping part (270) of the second sleeve (212), and the locking part (240) of the second sleeve (212) is locked with stopping part (330) of the base body (300).

9. The retractable insect and fly repelling device according to claim 8, wherein when the first sleeve (211) and the second sleeve (212) are guided into the accommodating state by the track and the slider structure, the first sleeve (211) is accommodated in the second sleeve (212), and the second sleeve is accommodated in the base body (300).

10. The retractable insect and fly repelling device according to claim 9, wherein the insect and fly repelling module (100) comprises a fan assembly and a power supply, wherein the fan assembly is fixedly connected with the sleeve (210) and comprises blades (111) and a motor; the power supply is fixedly connected with the base body (300) and electrically connected with the fan assembly.
